(19) United States
(12) Patent Application Publication
(10) Pub. No.: US 2008/0099579 A1
(43) Pub. Date: May 1, 2008

(54) Line Striper

(76) Inventors: James C. Schroeder, Ramsey, MN (US); Eric J. Finstad, Rogers, MN (US); Neil A. Taylor, Elk River, MN (US); Robert J. Gundersen, Otsego, MN (US)

Correspondence Address: GRACO MINNESOTA INC, PO BOX 1441, MINNEAPOLIS, MN, 55440, US

(21) Appl. No.: 11/721,455

(22) PCT Filed: Dec. 21, 2005
(86) PCT No.: PCT/US05/46336

§ 371 Date: Jun. 12, 2007

Related U.S. Application Data
(60) Provisional application No. 60/637,696, filed on Dec. 21, 2004.

(51) Int. Cl. B05B 1/28

(52) U.S. Cl. 239/150

(57) ABSTRACT

A line striper (10) is provided with a relatively small engine (16) operating a reciprocating piston pump (20) and having a centrifugal clutch (18) which actuates when a predetermined engine speed has been reached. A pressure bypass device (22) which opens at either a fixed or adjustable pressure is provided to bleed off excess pressure and maintain a consistent spraying pressure. A double acting trigger (30) is provided for the operator to actuate the spray gun (40) and raise the engine speed simultaneously.

### TECHNICAL FIELD

This application claims the benefit of U.S. application Ser. No. 60/637,696, filed on Dec. 21, 2004.

### BACKGROUND ART

Self-powered line stripers such as Graco's LINELAZER are well known. Such stripers typically have a gas engine also having an electrical output sufficient to operate an electrical clutch.

### DISCLOSURE OF THE INVENTION

It is therefore an object of this invention to provide a much lighter and lower cost striper by utilizing an engine without an electrical output. Towards this end, a relatively small engine is provided with a centrifugal clutch which actuates when a predetermined RPM level had been reached. A pressure bypass device (which opens at either a fixed or adjustable pressure is provided to bleed off excess pressure and maintain a consistent spraying pressure. A double acting trigger is provided for the operator to actuate the spray gun and raise the engine RPM simultaneously

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a perspective view of the striper of the instant invention.

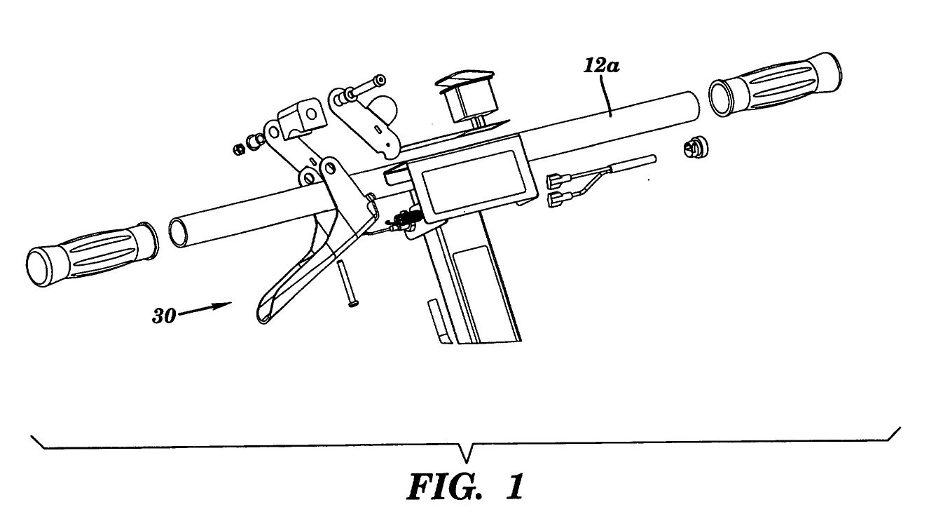

FIG. 2 is an exploded view of the trigger assembly.

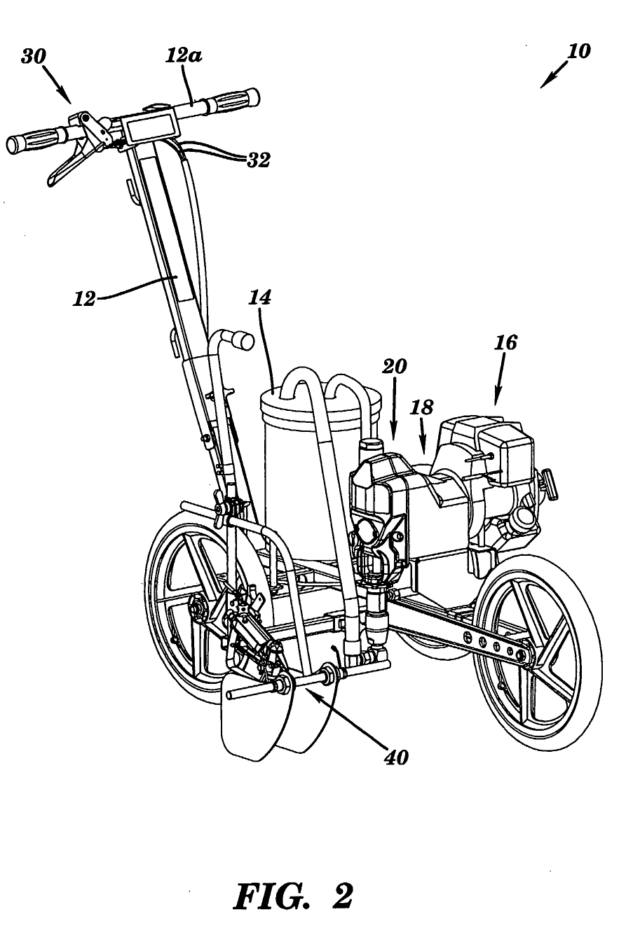

### BEST MODE FOR CARRYING OUT THE INVENTION

The striper of the instant invention, generally designated 10 is comprised of a cart 12 having located thereon a container 14 for paint or other material to be applied, a gasoline engine (or equivalent portable power source) 16, a pump 20 (preferably of the reciprocating piston type) and a centrifugal clutch 18 connecting engine 16 and pump 20. Clutch 18 is of the well known type that engages when a predetermined RPM level had been reached.

Attached to the outlet of pump 20 is a bypass valve 22 which, when a predetermined spraying pressure is exceeded, directs the pump output back to the container 14. This bypass 22 operates when the spray gun 40 is closed and not spraying or anytime the pump output exceeds that being used for spraying.

A trigger 30 is provided on the handlebar 12a of cart 12 which operates twin cables 32. A first cable 32 is connected to the throttle of engine 16. The second cable 32 is connected to spray gun 40 which is a conventional airless spray gun. Actuation of trigger 30 thus raises the engine 16 RPM, engages the clutch 18 and raises the pressure in pump 20 and well as opening spray gun 40 to initiate spraying. In the preferred embodiment, there is a slight lead/lag built into the cable arrangement (the spray gun cable 32 may have some slack in it) whereby the engine speed is brought up slightly before spraying is started. The trigger 30 is also constructed so as to allow is to be locked “on” so that that spray gun may be used as a hand spray gun by the operator (the spray gun cable 32 is detached from the gun 40) and the engine speed raised to a level suitable for spraying.

It is contemplated that various changes and modifications may be made to the line striper without departing from the spirit and scope of the invention as defined by the following claims.

1. A line striper for applying materials, said striper comprising:
an engine;
a pump having an outlet;
a centrifugal pump connecting said engine and said pump, said clutch engaging at a predetermined engine speed;
a spray gun; and
a trigger attached to said engine and said spray gun so that actuation of said trigger raises the speed of said engine and opens said spray gun.

2. The line striper of claim 1 wherein said trigger raises said engine speed before opening said spray gun.

3. The line striper of claim 1 further comprising a bypass valve connected to said pump outlet, said bypass valve opening upon attainment of a predetermined pressure.
